(19) United States
(12) Patent Application Publication
(10) Pub. No.: US 2012/0225308 A1
(43) Pub. Date: Sep. 6, 2012

(54) MULTILAYER SUBSTRATE AND METHOD FOR PRODUCING THE SAME, DIAMOND FILM AND METHOD FOR PRODUCING THE SAME

(75) Inventor: Hitoshi NOGUCHI, Annaka (JP)

(73) Assignee: SHIN-ETSU CHEMICAL CO., LTD., Tokyo (JP)

(21) Appl. No.: 13/471,396

(22) Filed: May 14, 2012

Related U.S. Application Data
(62) Division of application No. 12/654,797, filed on Jan. 4, 2010.

(30) Foreign Application Priority Data
Jan. 9, 2009 (JP) 2009-003088

(51) Int. Cl. C01B 31/00; B32B 15/04

(52) U.S. Cl. 428/457; 423/446

(57) ABSTRACT

The present invention is a multilayer substrate comprising, at least, a single crystal substrate, a diamond film vapor-deposited on the single crystal substrate, wherein the single crystal substrate is a single crystal Ir or a single crystal Rh and a method for producing a multilayer substrate comprising, at least, a step of vapor-depositing a diamond film on a single crystal substrate, wherein a single crystal Ir or a single crystal Rh is used as the single crystal substrate. As a result, there is provided a multilayer substrate having a high quality single crystal diamond film with a large area and with a high crystallinity as a continuous film in which the diamond and the single crystal substrate are not broken and a method for producing the multilayer substrate at low cost.

### PRIORITY INFORMATION

This is a Division of application Ser. No. 12/654,797 filed Jan. 4, 2010, which claims the benefit of Japanese Application No. 2009-003088 filed Jan. 9, 2009. The disclosure of each of the prior applications is hereby incorporated by reference herein in its entirety.

### BACKGROUND OF THE INVENTION

1. Field of the Invention

The present invention relates to a multilayer substrate used for production of devices and the like, and particularly a multilayer substrate having a diamond film.

2. Description of the Related Art

Diamond has a wide band gap of 5.47 eV and a very high dielectric breakdown electric field intensity of 10 MV/cm. Furthermore, it has the highest thermal conductivity in materials. Therefore, if this is used for an electronic device, the device is advantageous as a high output electronic device.

Furthermore, diamond has a high drift mobility and is the most advantageous as a high speed electronic device in semiconductors in comparison of Johnson performance index.

Accordingly, diamond is said to be the ultimate semiconductor suitable for high frequency/high power electronic devices.

Therefore, a multilayer substrate in which a diamond film and the like is laminated on a substrate has attracted attention.

Now, most of the single crystal diamonds for fabrication of a diamond semiconductor are diamonds referred to as Ib type formed by a high pressure method. The Ib type diamonds contain a large amount of nitrogen impurities and can only be obtained at a size of no more than about a 5 mm square. Therefore, their utility is low.

By contrast, Chemical Vapor Deposition (CVD) method has an advantage that a diamond film of polycrystalline diamond of a large area having a diameter of about 6 inches (150 mm) can be obtained with a high purity.

However, in the CVD method, it has been conventionally difficult to perform single crystallization suitable for general electric devices. This is caused by a single crystal Si having been used as a substrate conventionally. That is, this is because Si and diamond are very different in lattice constant (mismatch between them is 52.6%) and it is very difficult to heteroepitaxially grow a diamond on a silicon substrate.

Therefore, various kinds of studies has progressed and there are reports that it is effective that Pt or Ir is formed as a ground film and then a diamond film is formed thereon by the CVD method (see, for example, Y. Shintani, J. Mater. Res. 11, 2955 (1996), and K. Ohtsuka, Jpn. J. Appl. Phys. 35, L1072 (1996)).

In the current situation, the research relating to Ir has particularly progressed most. There is a method in which, first, by using a single crystal MgO as a substrate, an Ir film is heteroepitaxially grown thereon, and next by a direct-current plasma CVD method, the Ir film surface is pretreated by a bias treatment with a methane gas diluted by hydrogen, and a diamond film is grown on the Ir film. Thereby, there have been obtained diamonds having a conventional submicron size to a recent several millimeters' size.

### SUMMARY OF THE INVENTION

However, this method needs to perform the heteroepitaxial growth twice. Therefore, its production time is long, its step is complex and its production cost is high. Further, since the single crystal MgO substrate has a lot of defects, defects easily occur in the Ir film and the diamond film formed on the substrate surface. Moreover, since the difference of a linear expansion coefficient between the single crystal MgO substrate and the diamond film is large, the single crystal MgO substrate or the diamond film is broken by a stress difference.

The present invention was accomplished in order to solve the aforementioned problems, and its object is to provide a multilayer substrate having a high quality single crystal diamond film with a large area and with a high crystallinity as a continuous film in which the diamond and the single crystal substrate are not broken and a method for producing the multilayer substrate at low cost.

In order to accomplish the above object, the present invention provides a multilayer substrate comprising, at least, a single crystal substrate, a diamond film vapor-deposited on the single crystal substrate, wherein the single crystal substrate is a single crystal Ir or a single crystal Rh.

In this way, the multilayer substrate of the present invention comprises a diamond film vapor-deposited on the surface of the single crystal Ir or of the single crystal Rh that has a desired physical property, such as a linear expansion coefficient, a lattice constant or the like, that is close to that of a diamond. Thus, crystallinity of a ground substrate is remarkably higher in comparison with a conventional single crystal MgO or an Ir film heteroepitaxially grown on a surface thereof. Therefore, the diamond film epitaxially grown on the single crystal has few defects, and crystallinity is remarkably higher than the conventional multilayer substrate. In addition, the heteroepitaxial growth is needed only once, and since the used single crystal substrate can be reused repeatedly after taking out the diamond film, a cost can be greatly reduced. Furthermore, since the difference of a linear expansion coefficient between the single crystal substrate and the diamond film is smaller than the conventional multilayer substrate, it can be prevented the single crystal substrate and the diamond film from being broken by the stress.

Furthermore, the present invention provides a diamond film separated from the multilayer substrate described above.

As described above, the diamond film formed on the multilayer substrate of the present invention has few defects and a remarkably higher crystallinity in comparison with the conventional diamond film. The diamond film separated from the substrate also has fewer defects and a remarkably higher crystallinity in comparison with the conventional diamond film.

Furthermore, the present invention provides a device produced by using the multilayer substrate described above.

As described above, since the present invention can provide the multilayer substrate having the high quality diamond film that has few defects, use of such multilayer substrate enables producing a high precision device at high yield.

Furthermore, the present invention provides a device produced by using the diamond film described above.

As described above, since the present invention can provide the high quality diamond film that has few defects, use of such diamond film enables producing a high precision device at high yield.

Furthermore, the present invention provides a method for producing a multilayer substrate comprising, at least, a step of vapor-depositing a diamond film on a single crystal substrate, wherein a single crystal Ir or a single crystal Rh is used as the single crystal substrate.

According to the present invention, since the diamond film is vapor-deposited on a surface of the single crystal Ir or of the single crystal Rh that has a desired physical property, such as a linear expansion coefficient, a lattice constant or the like, that is close to that of a diamond, the heteroepitaxial growth is needed only once. Moreover, since the single substrate can be reused repeatedly after delaminating the diamond film, the multilayer substrate can be produced with reducing its production cost and its production time. Moreover, since crystallinity of the ground substrate is remarkably higher than the conventional heteroepitaxial growth film, defects in the diamond film vapor-deposited on the single crystal substrate can be reduced and crystallinity can be high.

Moreover, in the method for producing a multilayer substrate of the present invention, it is preferable that the vapor deposition of a diamond film is performed by a microwave CVD method or a direct-current plasma CVD method.

Thereby, there can be more certainly obtained a continuous film of a single crystal diamond with a large area.

Moreover, in the method for producing a multilayer substrate of the present invention, it is preferable that the surface of the single crystal substrate is pretreated by a DC (Direct-Current) plasma method before the step of the vapor deposition of a diamond film.

It is thought that by pretreating the surface of the single crystal substrate as described above, nanosize diamond microparticles are formed on the surface of the single crystal substrate. Therefore, it becomes easy to vapor-deposit subsequently the diamond film on the single crystal substrate surface.

Furthermore, the present invention provides a method for producing a diamond film comprising, at least, a step of vapor-depositing a diamond film on a single crystal substrate and a step of separating the diamond film from the single crystal substrate, wherein a single crystal Ir or a single crystal Rh is used as the single crystal substrate.

According to the present invention, since the diamond film is vapor-deposited on a surface of the single crystal Ir or of the single crystal Rh that has a desired physical property, such as a linear expansion coefficient, a lattice constant or the like, that is close to that of a diamond, the multilayer substrate that needs only one time heteroepitaxial growth can be produced. Moreover, since crystallinity of the ground substrate is remarkably higher than the conventional heteroepitaxial growth film, the diamond film that has few defects and a high crystallinity can be obtained by separating the diamond film vapor-deposited on the single crystal substrate described above from the single crystal substrate.

Moreover, in the method for producing a diamond film of the present invention, it is preferable that the vapor deposition of a diamond film is performed by a microwave CVD method or a direct-current plasma CVD method.

Thereby, there can be more certainly obtained a continuous film of a single crystal diamond with a large area.

Moreover, in the method for producing a diamond film of the present invention, it is preferable that a surface of the single crystal substrate is pretreated by a DC plasma method before the step of the vapor deposition of a diamond film.

It is thought that by pretreating the surface of the single crystal substrate as described above, nanosize diamond microparticles are formed on the surface of the single crystal substrate. Therefore, it becomes easy to vapor-deposit subsequently the diamond film on the single crystal substrate surface.

As explained above, according to the present invention, there can be provided a multilayer substrate having a high quality single crystal diamond film with a large area as a continuous film at low cost.

### BRIEF DESCRIPTION OF DRAWINGS

FIG. 1 is a schematic section view showing an example of a multilayer substrate of the present invention;

FIG. 2 is a flow chart showing an example of a method for producing a multilayer substrate of the present invention;

FIG. 3 is a schematic view of a pretreatment apparatus that is used in the producing method of the present invention;

FIG. 4 is a schematic view of a microwave CVD apparatus used in the producing method of the present invention.

### DETAILED DESCRIPTION OF THE PREFERRED EMBODIMENTS

Hereinafter, embodiments of the present invention will be explained. However, the present invention is not limited by these explanations.

As mentioned above, the conventional multilayer substrate had a problem that a MgO substrate or a diamond is easily broken particularly due to stress caused by the difference of a linear expansion coefficient between the MgO substrate and the diamond film, and particularly a single crystal diamond film with a large area cannot be obtained as a continuous film.

Accordingly, the present inventor diligently studied for solving such a problem.

As a result, the present inventor found that if a single crystal in which the difference of a linear expansion coefficient from that of a diamond is as small as possible is used as a single crystal to be a substrate, and if a diamond film is vapor-deposited on the single crystal, a high quality diamond film can be obtained on the substrate even if it has a large area. Thereby, the present invention was accomplished.

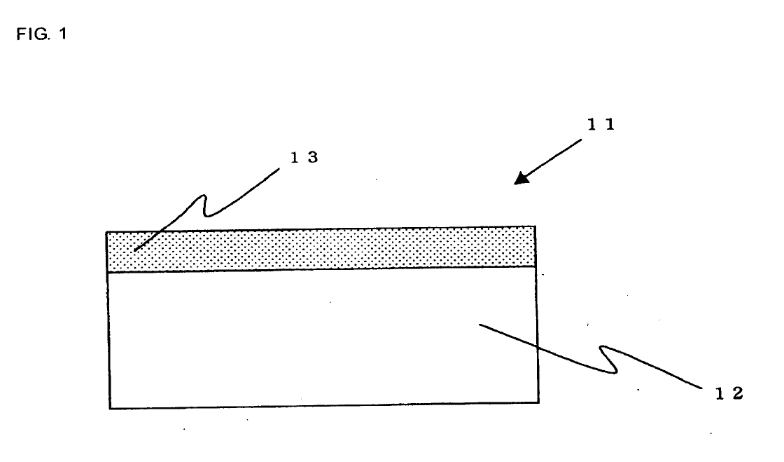

Here, an example of the multilayer substrate of the present invention is shown in FIG. 1. This multilayer substrate 11 has a single crystal substrate 12 consisted of Ir or Rh and a diamond film 13 vapor-deposited on the single crystal substrate 12.

In the multilayer substrate 11 of the present invention, the single crystal Jr or the single crystal Rh, which has a good crystallinity and a desired physical property, such as a linear expansion coefficient, a lattice constant or the like, that is close to that of a diamond, is used as the substrate 12. Thus, since crystallinity of the substrate for vapor-depositing a diamond thereon is remarkably higher than the conventional substrate in which Ir is heteroepitaxially grown, the defects is more difficult to be caused in the diamond film and crystallinity of the diamond film can be made higher than the conventional diamond film.

Moreover, since a linear expansion coefficient of Jr or Rh is closer to that of a diamond in comparison with a conventional MgO substrate, the stress of the produced diamond film can be made small. Therefore, warpage of the produced diamond film can be made small and thereby it can be prevented the diamond film and/or the single crystal substrate from being broken (a linear expansion coefficient In7.1×10⁻⁶ K⁻¹, , Rh:8.2×10⁻⁶ K⁻¹, diamond:1.1×10⁻⁶ K⁻¹, MgO:13.8×10⁻⁶ K⁻¹).

Moreover, the single crystal substrate can be reused repeatedly for producing the multilayer substrate by delaminating the diamond from the single crystal Ir substrate or single crystal Rh substrate after vapor deposition.

Conventionally, an Ir layer is heteroepitaxially grown on a single crystal MgO substrate, and then the diamond film is vapor-deposited on the Ir/MgO substrate and thus the Ir layer is heteroepitaxially grown in every production of the multilayer substrate. However, since the multilayer substrate of the present invention does not need this step, a production process can be simplified and a production cost can be reduced.

Particularly, a single crystal Jr is preferably used as the single crystal used for the substrate.

By using the single crystal Jr for the substrate, a higher quality epitaxial film of which a lattice constant is close to a diamond can be grown, and the diamond film with a large area can be formed as a continuous film (a lattice constant diamond:3.56 Å, Ir:3.84 Å, Rh:3.80 Å).

Moreover, the diamond film separated from such multilayer substrate has few defects and a high crystallinity. In addition, it has a large area and thus a high precision device can be produced at high yield and at low cost.

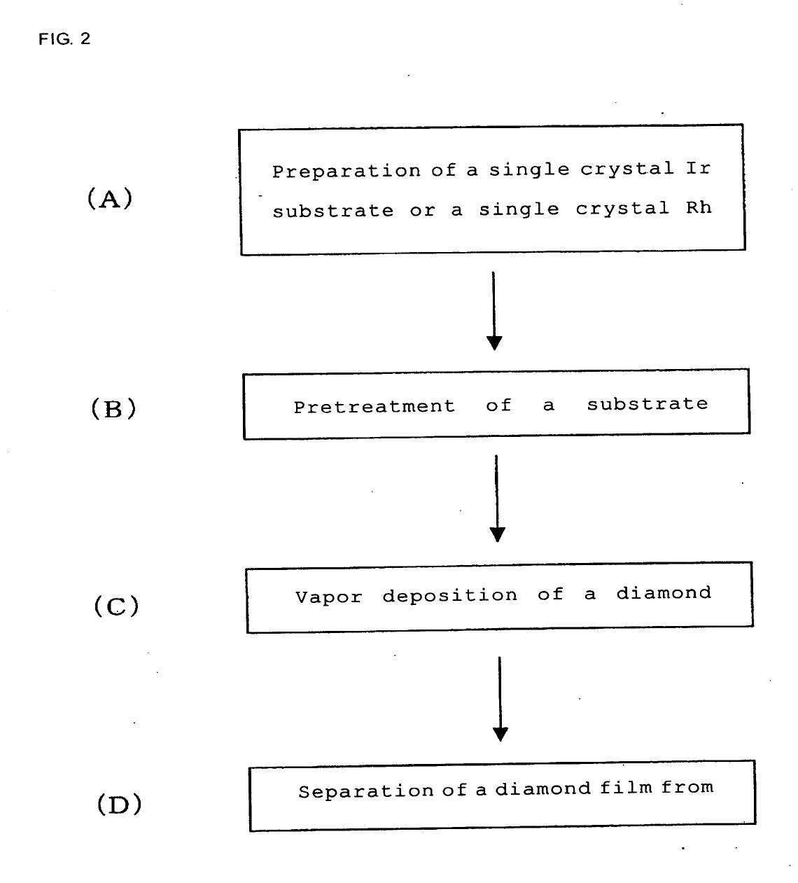

Next, an example of a method for producing a multilayer substrate of the present invention described above is shown as a flow chart in FIG. 2.

As shown in FIG. 2, the multilayer substrate of the present invention can be produced through a step (A) of preparing a single crystal Ir substrate or a single crystal Rh substrate and a step (C) of vapor-depositing a diamond film on the substrate. In this case, as an optional step, a step (B) of pretreating a surface of the single crystal substrate by a DC plasma method may be performed before the step (C) of the vapor deposition of a diamond film. In addition, after that, a step (D) of separating the diamond film from the single crystal substrate may be performed.

First, the step (A) of preparing a single crystal Ir substrate or a single crystal Rh substrate will be explained.

For example, a single crystal Ir or a single crystal Rh produced by FZ method may be used and a commercial single crystal may be used.

Next, an example of the step (C) of vapor deposition of a diamond film will be explained.

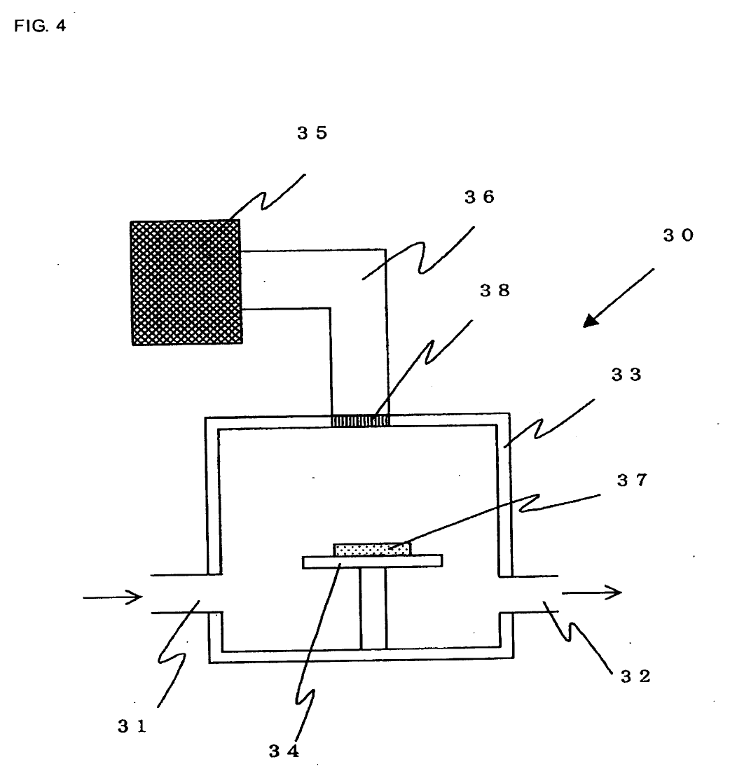

As explaining the outline, the diamond film is vapor-deposited on the single crystal Ir substrate or on the single crystal Rh substrate by using a microwave CVD apparatus 30 as shown in FIG. 4.

The detail will be explained. In this microwave CVD apparatus 30, a stage 34 loaded with a heating body such as a heater is placed in a chamber 33 having a gas inlet pipe 31 and a gas outlet pipe 32. A microwave power source 35 is connected with a microwave guide window 38 through a waveguide 36 so that plasma can be generated in the chamber 33.

For performing vapor deposition of the diamond film by using the microwave CVD apparatus 30, the single crystal Ir or the single crystal Rh substrate 37 is placed on the stage 34, and then the inside of the chamber 33 is exhausted by a rotary pomp and thereby the pressure in the chamber 33 is reduced to 10⁻³ Torr (about 1.3×10¹ Pa) or less. Next, a desired flow amount of a material gas such as a methane gas diluted by hydrogen is introduced in the chamber 33 from an gas inlet pipe 31. Next, after a valve of a gas outlet pipe 32 is adjusted and thereby the inside of the chamber 33 is made to become a desired pressure, microwave is applied from a microwave power source 35 and a waveguide 36 and thereby plasma is generated in the chamber 33, resulting in heteroepitaxially growing the diamond film on the substrate 37.

Plasma and the substrate temperature can be controlled with relative independence by the microwave CVD method. Therefore, it is easy that the diamond film is vapor-deposited and the temperature is set to 800-1000 C°, which is such a substrate temperature in the film-forming that the delamination is more difficult to be caused. In this case, the frequency may be 2.45 GHz or 915 MHz.

Such microwave CVD method can be used for even a large substrate size of a 10 mm square or more.

Moreover, the direct-current plasma CVD method can be used in the step (C) of vapor deposition of a diamond film.

Conventionally, when the diamond film is formed by the DC plasma method, the substrate temperature reaches 800 C.° to 1400 C.° and particularly there is a fear that the MgO substrate or the diamond is broken due to the difference of a linear expansion coefficient between MgO and diamond. However, the present invention does not bring about such problem and thus the diamond film can be vapor-deposited by the DC plasma method.

Here, the step (B) of pretreatment by the DC plasma method, which is an optional step, will be explained.

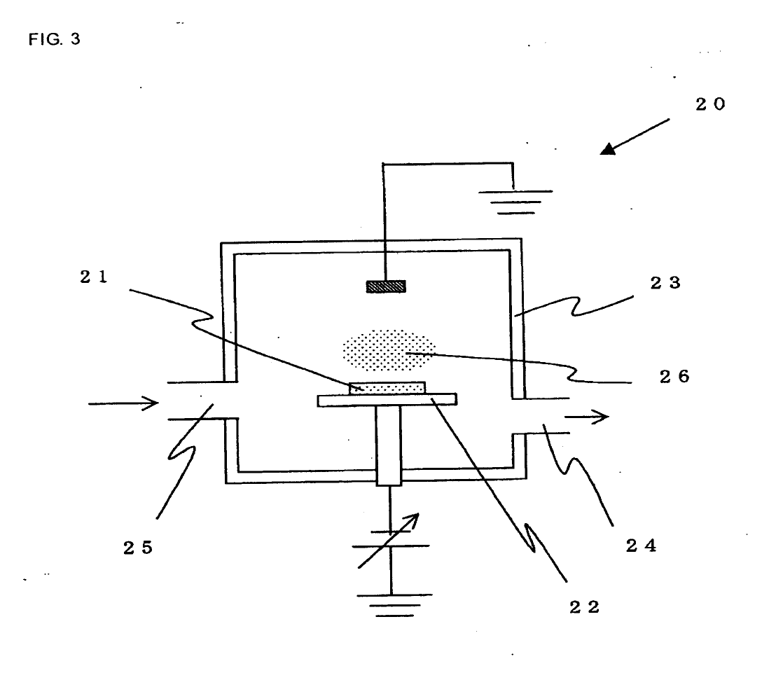

As explaining the outline, the surface of the single crystal substrate is ion-irradiated by using a DC plasma apparatus 20 as shown in FIG. 3.

The detail will be explained. First, the substrate 21 consisted of a single crystal Ir or a single crystal Rh is set on an electrode 22 of the negative voltage-applying side and then exhaust is performed by a vacuum pump from a gas outlet pipe 24 and thereby the pressure in the chamber 23 is reduced to 10⁻⁷ Torr. Next, a gas (for example, methane diluted by hydrogen: H₂/CH₄) is introduced from an inlet pipe 25 and a discharge is performed by applying a DC voltage to the electrode and thereby plasma 26 is generated, resulting in pretreating the surface of the substrate 21.

It is thought that by this pretreatment, nanosize diamond microparticles (nuclei of diamond) are formed on the single crystal substrate. Therefore, in the subsequent step (c) of vapor deposition of a diamond film, it becomes easy to vapor-deposit the diamond film on the single crystal substrate.

Next, the step (D) of separating the diamond film from the single crystal substrate will be explained.

When the multilayer substrate is cooled from a high temperature heating condition to low temperatures, the diamond film can be separated by actively using the stress generated at an interface between the single crystal substrate and the diamond film due to the difference of a linear expansion coefficient between the single crystal substrate and the diamond film.

Moreover, an ion implantation delamination method of implanting ions at the interface and separating the diamond film at the implanting layer by heating the multilayer substrate can be used.

The multilayer substrate of the present invention obtained by the method as described above has the diamond film with a high crystallinity formed thereon. Therefore, use of such multilayer substrate and the diamond film separated from the substrate enables an excellent high frequency/high power electronic devices at high yield.

It is to be noted that the present invention is not restricted to the foregoing embodiment. The embodiment is just an exemplification, and any examples that have substantially the same feature and demonstrate the same functions and effects as those in the technical concept described in claims of the present invention are included in the technical scope of the present invention.

What is claimed is:

1. A device comprising a multilayer substrate comprising, at least, a single crystal substrate, and a diamond film vapor-deposited on the single crystal substrate, wherein the single crystal substrate is a single crystal Ir or a single crystal Rh.

2. A device comprising a diamond film, wherein the diamond film is separated from a multilayer substrate comprising, at least, a single crystal substrate, and a diamond film vapor-deposited on the single crystal substrate, wherein the single crystal substrate is a single crystal Ir or a single crystal Rh.
